(19) United States
(12) Patent Application Publication
(10) Pub. No.: US 2026/0192263 A1
(43) Pub. Date: Jul. 9, 2026

(54) FLUID MIXER

(71) Applicant: Panasonic Intellectual Property Management Co., Ltd., Osaka (JP)

(72) Inventors: HIROAKI YOSHIDA, Osaka (JP); TAICHI NAKAMURA, Osaka (JP); RYO MIYA, Osaka (JP); YONGSHIN LEE, Osaka (JP)

(21) Appl. No.: 19/535,244

(22) Filed: Feb. 10, 2026

Related U.S. Application Data
(63) Continuation of application No. PCT/JP2024/032376, filed on Sep. 10, 2024.

(30) Foreign Application Priority Data
Oct. 18, 2023 (JP) 2023-179757

(51) Int. Cl. B01F 25/313; B01F 23/451; B01F 25/431

(52) U.S. Cl. CPC B01F 25/3133; B01F 23/451; B01F 25/3131; B01F 25/431; B01F 2215/0431

(57) ABSTRACT

A fluid mixer includes a liquid-contact component including a first tubular body and a second tubular body disposed to form a double tube in a portion inside the first tubular body, the liquid-contact component allowing a first fluid to flow between an inner wall of the first tubular body and an outer wall of the second tubular body, and allowing a second fluid to flow inside the second tubular body, and includes a static mixer unit fluidly connected to the liquid-contact component, the static mixer unit including a fluid mixture structure that promotes mixing of the first fluid and the second fluid, in which the second tubular body includes a tip, and a gap is provided between the tip and the fluid mixture structure.

### TECHNICAL FIELD

The present disclosure relates to a mixer that mixes a plurality of fluids in a channel.

### BACKGROUND ART

A method for manufacturing fine particles using a reaction in a liquid phase is industrially expected because not only a synthesis process is simpler than that in a method for manufacturing fine particles using a reaction in a gas phase such as a sputtering method, but also mass production can be performed at a time.

Examples of a method for precisely and continuously performing reaction in a liquid phase include a method called microflow synthesis. The microflow synthesis is a synthesis method in which a plurality of unit operations such as mixing and heating are continuously performed in a single continuous process in a minute space, and has high process controllability and high throughput compared to a synthesis method in which each unit operation is discontinuously performed in order by using a reaction pot called batch synthesis. Thus, when the microflow synthesis is applied to manufacturing of fine particles and polymers, highly accurate control of a particle size, molecular weight, composition, and the like is expected.

To apply the microflow synthesis to stable microparticle synthesis, preventing channel blockage caused by a compound is indispensable.

Examples of a conventional mixer for preventing channel blockage include a two-liquid mixing mixer including a double tube structure and a static mixer (e.g., see PTL 1).

### CITATION LIST

### Patent Literature

PTL 1: Japanese Patent No. 6668792

### SUMMARY OF THE INVENTION

In a crystallization process with a large amount of solid to be produced, the conventional mixer is likely to cause channel blockage, and thus cannot be used. When applied to a process such as a crystallization reaction in which a solid content is immediately generated after a plurality of fluids are mixed, the conventional mixer causes channel blockage due to a product attached to the static mixer and accumulated inside a double tube. Thus, to apply the microflow synthesis to manufacturing of particles using the crystallization reaction or the like, a fluid mixer has a problem requiring high mixing performance that enables rapid mixing of fluids and more excellent adhesion prevention and removal effect of a product on a channel.

The present disclosure has been made to solve the above-mentioned conventional problems, and an object of the present disclosure is to provide a mixer having more excellent adhesion prevention and removal effect of a product on a channel while maintaining mixing performance.

A fluid mixer according to an aspect of the present disclosure includes a liquid-contact component including a first tubular body and a second tubular body disposed to form a double tube in a portion inside the first tubular body, the liquid-contact component allowing a first fluid to flow between an inner wall of the first tubular body and an outer wall of the second tubular body, and allowing a second fluid to flow inside the second tubular body, and includes a static mixer unit fluidly connected to the liquid-contact component, the static mixer unit including a fluid mixture structure that promotes mixing of the first fluid and the second fluid, in which the second tubular body includes a tip, and a gap is provided between the tip and the fluid mixture structure.

According to the fluid mixer according to an aspect of the present disclosure, a product generated by mixing a plurality of fluids is less likely to adhere to an upstream channel, and the product having adhered is also likely to be removed by a flow field of a fluid. Consequently, a fluid mixer having a more excellent blockage prevention effect while maintaining mixing performance can be provided.

### BRIEF DESCRIPTION OF THE DRAWINGS

FIG. 1 is a schematic sectional view illustrating a sectional structure of a fluid mixer according to a first exemplary embodiment.

FIG. 2 includes part (a) that is an enlarged sectional view taken along a flow direction (X direction) near a tip of a second tubular body, and part (b) that is an enlarged sectional view taken along a direction perpendicular to the flow direction.

FIG. 3 is an enlarged sectional view illustrating a flowing state of a fluid at a connection place between a liquid-contact component and a static mixer unit in an exemplary embodiment.

FIG. 4 is a table showing evaluation of mixing performance, and adhesion prevention and removal effect of a product on a channel.

### DESCRIPTION OF EMBODIMENT

A fluid mixer according to a first aspect of the present disclosure includes a liquid-contact component including a first tubular body and a second tubular body disposed to form a double tube in a portion inside the first tubular body, the liquid-contact component allowing a first fluid to flow between an inner wall of the first tubular body and an outer wall of the second tubular body, and allowing a second fluid to flow inside the second tubular body, and includes a static mixer unit fluidly connected to the liquid-contact component, the static mixer unit including a fluid mixture structure that promotes mixing of the first fluid and the second fluid, in which the second tubular body includes a tip, and a gap is provided between the tip and the fluid mixture structure.

A fluid mixer according to a second aspect in the first aspect includes the second tubular body that may have inner diameter “a” from 0.1 mm to 10 mm inclusive.

A fluid mixer according to a third aspect in the first or second aspect includes the second tubular body and the fluid mixture structure that may be physically separated from each other by gap length “d”. The gap length “d” may satisfy Expression (1) below.

$$0.2 a \leq d \leq 500 a \qquad ( 1 )$$

A fluid mixer according to a fourth aspect in any one of the first to third aspects includes the second tubular body with the tip that may have a tapered shape.

A fluid mixer according to a fifth aspect in any one of the first to fourth aspects may have sectional area S2 and area S1 that satisfy Expression (2) below,

$$S 2 / S 1 \leq 3.09 \qquad ( 2 )$$

where sectional area S2 may be a sectional area of an inner peripheral part of the second tubular body in an end surface of the tip of the second tubular body, and area S1 may be an area obtained by subtracting a sectional area of an outer peripheral part of the second tubular body from a sectional area of an inner peripheral part of the first tubular body.

Hereinafter, a fluid mixer according to an exemplary embodiment will be described with reference to the accompanying drawings. However, unless otherwise specified, the components, types, combinations, shapes, relative positions, and the like described in the exemplary embodiment are not intended to limit the scope of the present disclosure only thereto, and are merely illustrative examples.

### First Exemplary Embodiment

### <Fluid Mixer 1>

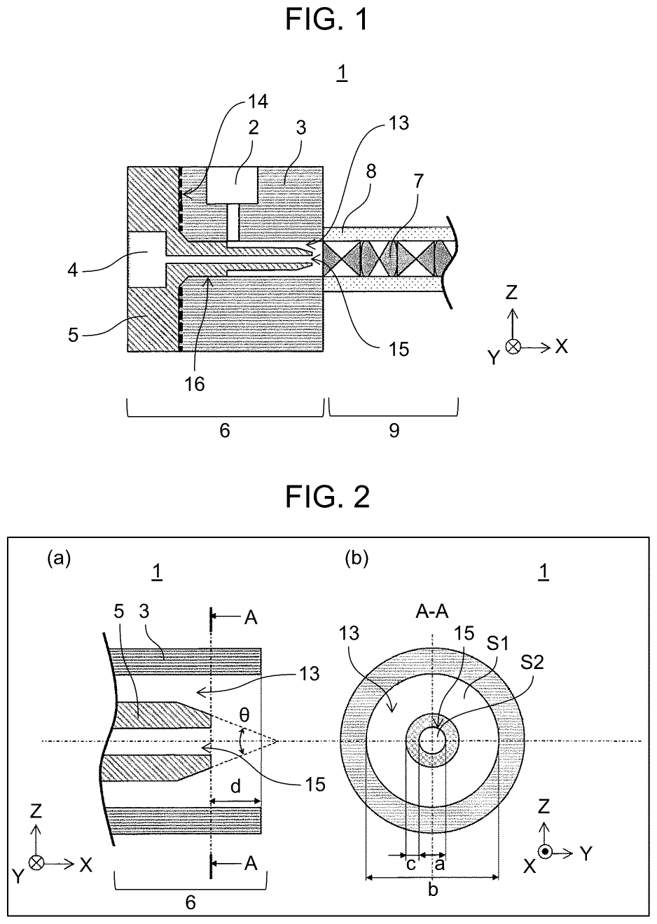

FIG. 1 is a schematic sectional view illustrating a sectional structure of fluid mixer 1 according to a first exemplary embodiment. For convenience, a direction of a flow of a fluid is indicated as an X direction, a direction backward from forward across the paper surface among directions perpendicular to the X direction is indicated as a Y direction, and a direction from a lower part to an upper part of the paper surface is indicated as a Z direction.

Fluid mixer 1 according to the first exemplary embodiment includes liquid-contact component 6 that causes a first fluid and a second fluid to flow, and static mixer unit 9 that is connected to liquid-contact component 6 while allowing a fluid to flow and that includes fluid mixture structure 7 that promotes mixing of the first fluid and the second fluid. Liquid-contact component 6 includes first tubular body 3, and second tubular body 5 disposed in a part of the inside of first tubular body 3 while forming a double tube. The first fluid is allowed to flow between an inner wall of first tubular body 3 and an outer wall of second tubular body 5. The second fluid is allowed to flow inside second tubular body 5. Liquid-contact component 6 includes first pipe connector 2 for transporting the first fluid to first tubular body 3. Liquid-contact component 6 further includes second pipe connector 4 for transporting the second fluid to second tubular body 5. Static mixer unit 9 further includes third tubular body 8 that internally houses fluid mixture structure 7. When the first fluid and the second fluid come into contact with each other at the tip of second tubular body 5, mixing of the two fluids is started, and fluid mixture structure 7 located downstream causes the mixing of the fluids to further proceed. The tip of second tubular body 5 and fluid mixture structure 7 are physically separated from each other by gap length “d”. Gap length “d” satisfies Expression (1) below, which is a relational expression with inner diameter “a” of second tubular body 5.

$$0.2 a \leq d \leq 500 a \qquad ( 1 )$$

Fluid mixture structure 7 may accumulate a product. Gap length “d” of 0.2a or more prevents the accumulated product from reaching second tubular body 5, thus preventing second tubular body 5 from being blocked. Meanwhile, gap length “d” of 500a or less shortens time from contact between the first fluid and the second fluid to completion of mixing, thus improving mixing performance of fluid mixer 1.

The fluid mixer according to the first exemplary embodiment is configured to allow the tip of the second tubular body to be disposed without being in physical contact with the fluid mixture structure. This configuration enables achieving not only prevention of adhesion of a product to a channel and removal of the product from the channel, but also mixing performance.

Hereinafter, each component of the fluid mixer will be described.

### <Liquid-Contact Component 6>

As described above, liquid-contact component 6 includes first tubular body 3, and second tubular body 5 disposed in a part of the inside of first tubular body 3 while forming a double tube. Liquid-contact component 6 includes first pipe connector 2 for transporting the first fluid to first tubular body 3. Liquid-contact component 6 further includes second pipe connector 4 for transporting the second fluid to second tubular body 5.

### <First Pipe Connector 2>

First pipe connector 2 connects first tubular body 3 to a pipe for transporting the first fluid. As first pipe connector 2, members such as a tapered screw, a parallel screw, and a hose joint can be used.

### <First Tubular Body 3>

First tubular body 3 includes cavity 13 into which the first fluid can be transported. First tubular body 3 receives a part of second tubular body 5 inside cavity 13. First tubular body 3 can be acquired by processing stainless steel such as SUS304, SUS316, or SUS316L, a metal material such as Hastelloy, or a resin material such as PP, PFA, PTFE, PEEK, or PPS, or a tube of each material can be used as first tubular body 3, for example. Cavity 13 has a section perpendicular to its axis, and the section may have any one of an elliptical shape, a circular shape, a polygonal shape, and the like, and has a circular shape, for example.

### <Second Pipe Connector 4>

Second pipe connector 4 connects second tubular body 5 to a pipe for transporting the second fluid. As second pipe connector 4, members such as a tapered screw, a parallel screw, and a hose joint can be used.

### <Second Tubular Body 5>

Second tubular body 5 includes cavity 15 into which the second fluid can be transported. Additionally, the outside of second tubular body 5 may be partially in contact with the first fluid in cavity 13 inside first tubular body 3. Second tubular body 5 can be acquired by processing stainless steel such as SUS304, SUS316, or SUS316L, a metal material such as Hastelloy, or a resin material such as PP, PFA, PTFE, PEEK, or PPS, or a tube of each material can be used as second tubular body 5, for example. Cavity 15 has a section perpendicular to its axis, and the section may have any one of an elliptical shape, a circular shape, a polygonal shape, and the like, and has a circular shape, for example. When the sectional shape of cavity 15 with respect to the axis is circular, a contact interface between the first fluid and the second fluid can be formed in an axially symmetric manner more accurately.

Cavity 15 of second tubular body 5 preferably has inner diameter “a” from 0.1 mm to 10 mm inclusive. Inner diameter “a” of 0.1 mm or more reduces pressure loss in the channel to promote liquid feeding, thus being desirable from the viewpoint of manufacturing a material. Inner diameter “a” of 0.1 mm or more is also desirable from the viewpoint of processing accuracy during preparation of second tubular body 5. Inner diameter “a” of 10 mm or less is desirable because the second fluid flowing near the center of cavity 15 of second tubular body 5 is mixed with the first fluid in a short time to enhance mixing performance of the fluid mixer.

### <Placement of First Tubular Body 3 and Second Tubular Body>

As illustrated in FIG. 1, first tubular body 3 internally includes cavity 13 that houses a part of second tubular body 5. That is, first tubular body 3 and second tubular body 5 are disposed forming a double tube structure in which the axial direction (X direction) of cavity 13 of first tubular body 3 is aligned with the axial direction (X direction) of cavity 15 of second tubular body 5.

A double pipe structure as described above has been conventionally acquired in many cases by connecting two tubular bodies in which inner surface 16 of one of the tubular bodies is threaded and in contact with the other of the tubular bodies in parallel in the axial direction. Unfortunately, this configuration causes insufficient concentricity in a part of the double pipe.

Fluid mixer 1 according to the first exemplary embodiment includes first tubular body 3 and second tubular body 5 that are connected by using a surface intersecting the axial direction (X direction), such as vertical end surface 14 in FIG. 1, instead of inner surface 16 parallel to the axial direction (X direction). This configuration allows first tubular body 3 to align with second tubular body 5 on the plane (Y-Z plane) perpendicular to the axial direction (X direction) with higher accuracy, thus securing sufficient concentricity. The connection surface between first tubular body 3 and second tubular body 5 is not limited to a surface perpendicular to the axial direction (X direction), and may be any surface intersecting the axial direction (X direction). For example, the connection surface is only required to intersect the axial direction (X direction) at 30 degrees or more. The connection surface may intersect the axial direction at 45 degrees or more.

Consequently, sufficient concentricity between the axis of cavity 13 of first tubular body 3 and the axis of cavity 15 of second tubular body 5 can be acquired.

### <Relationship Between First Tubular Body 3 and Tip of Second Tubular Body 5>

Part (a) of FIG. 2 is an enlarged sectional view taken along a flow direction (X direction) near a tip of second tubular body 5, and part (b) of FIG. 2 is an enlarged sectional view taken along a direction perpendicular to the flow direction.

The tip of second tubular body 5 is preferably tapered. When the tip of second tubular body 5 has a tapered shape, a shearing force due to a flow of a component of the second fluid in a cylinder center direction (X direction) is generated at a contact place between the interface between the first fluid and the second fluid, and second tubular body 5, thus allowing a product adhering to the contact place between the interface between the first fluid and the second fluid, and second tubular body 5 to be likely to be removed. Even when axes of first tubular body 3 and second tubular body 5 do not coincide with each other with high accuracy, the tip of second tubular body 5 does not come into contact with first tubular body 3. Thus, the first fluid and the second fluid can be stably brought into contact with each other, so that adhesion of products to the channel can be further reduced. The tapered shape of the tip of second tubular body 5 preferably has taper angle θ from 10° to 150° inclusive, and more preferably has taper angle θ from 15° to 90° inclusive. Taper angle θ of 10° or more enhances an effect of removing attached substances using the shearing force caused by the flow of the component of the second fluid in the cylinder center direction (X direction), thus facilitating exhibition of a desired effect. Meanwhile, taper angle θ of 150° or less prevents the tapered part from becoming a stagnation point to cause a product generated at the interface between the first fluid and the second fluid to be less likely to adhere to the tapered part, thus facilitating exhibition of a desired effect.

Part (b) of FIG. 2 illustrates sectional area S2 and area S1 that preferably satisfy Expression (2) below. Sectional area S2 is of an inner peripheral part of second tubular body 5 at the end surface of the tip of second tubular body 5. Area S1 is obtained by subtracting a sectional area of an outer peripheral part of second tubular body 5 from a sectional area of an inner peripheral part of first tubular body 3.

$$S 2 / S 1 \leq 3.09 \qquad ( 2 )$$

When the first fluid and the second fluid come into contact with each other, a product is generated at the interface between the first fluid and the second fluid. The first fluid and the second fluid come into contact with each other at a position away from the inner wall of first tubular body 3, so that the product can be prevented from adhering to the inner wall of first tubular body 3. S2/S1 of 3.09 or less shows that the interface between the first fluid and the second fluid separates from the inner wall of first tubular body 3, and thus is desirable to reduce a possibility that the product adheres to the inner wall of first tubular body 3 due to diffusion or precipitation. Second tubular body 5 desirably has inner diameter “a” of 0.1 mm or more from the viewpoint of processing accuracy of the member, and first tubular body 3 desirably has inner diameter “b” of 20 mm or less from the viewpoint of mixing performance. Thus, S2/S1 preferably has a value of 2.5×10⁻⁵ or more that is a numerical value corresponding to when second tubular body 5 has inner diameter “a” of 0.1 mm, first tubular body 3 has inner diameter “b” of 20 mm, and the tip of second tubular body 5 has thickness “c” of 0.2 mm.

### <Static Mixer Unit 9>

Static mixer unit 9 is connected to liquid-contact component 6 while allowing a fluid to flow and includes fluid mixture structure 7 that promotes mixing of the first fluid and the second fluid. Static mixer unit 9 further includes third tubular body 8 that internally houses fluid mixture structure 7.

### <Fluid Mixture Structure 7>

Fluid mixture structure 7 may be any structure as long as fluid mixing is promoted by stirring or diffusion. Available examples thereof include a structure in the shape of a stirring blade and a structure in which dividing and merging of fluid are repeated multiple times.

### <Third Tubular Body 8>

Third tubular body 8 is only required to be able to transport a mixture of the first fluid and the second fluid and to be able to be connected to second tubular body 5 while including fluid mixture structure 7 inside. Third tubular body 8 can be acquired by processing stainless steel such as SUS304, SUS316, or SUS316L, a metal material such as Hastelloy, or a resin material such as PP, PFA, PTFE, PEEK, or PPS, or a tube of each material provided with a connector can be used as third tubular body 8, for example.

### EXAMPLE

Fluid mixer 1 according to the present exemplary embodiment was prototyped, and lithium aluminum fluoride fine particles were manufactured by flow synthesis. Then, mixing performance, and adhesion prevention and removal effect of a product on a channel of fluid mixer 1 were verified, and thus will be described in detail.

### Example 1

To verify effect of second tubular body 5 and fluid mixture structure 7, which are not in physical contact with each other, fluid mixer 1 was prototyped. Then, the mixing performance, and the adhesion prevention and removal effect of a product on a channel, were evaluated.

### <Method for Manufacturing Fluid Mixer 1>

The first fluid was transported using a pipe acquired by attaching fitting 10 of ¼-28UNF to a PFA tube having an inner diameter of 1 mm and an outer diameter of 1.59 mm.

First pipe connector 2 was prepared by processing first tubular body 3 with a screw standard of ¼-28UNF, and was connected to the pipe for transporting the first fluid.

First tubular body 3 was prepared by processing a cylinder made of SUS316 into a cylindrical shape having an inner diameter of 2.18 mm.

The second fluid was transported using a pipe acquired by attaching fitting 10 of ¼-28UNF to a PFA tube having an inner diameter of 1 mm and an outer diameter of 1.59 mm.

Second pipe connector 4 was prepared by processing second tubular body 5 with the screw standard of ¼-28UNF, and was connected to the pipe for transporting the second fluid.

Second tubular body 5 was formed by processing a cylinder made of SUS316 while having an inner diameter of 0.5 mm, and including a tip that partially had an outer diameter of 2.18 mm to be inserted into a part of first tubular body 3. Second tubular body 5 at the tip had an outer diameter of 0.9 mm, and second tubular body 5 had a tip thickness of 0.2 mm. Second tubular body 5 was prepared with a distance of 2.18 mm between a tip of first tubular body 3 and one of end surfaces of second tubular body 5 when second tubular body 5 was assembled with first tubular body 3.

Liquid-contact component 6 was prepared by assembling first tubular body 3 and second tubular body 5 to be in contact with each other at their end surfaces perpendicular to the longitudinal direction of the cylinder, and fastening the end surfaces with a screw.

Fluid mixture structure 7 was acquired by processing a plate material made of SUS316 to include ten right torsion blades that were alternately connected to corresponding ten left torsion blades in a flow direction of the fluid to have an outer diameter of 2.18 mm perpendicular to the longitudinal direction of the connected body.

As third tubular body 8, fitting 10 of ¼-28UNF attached to a PFA tube having an inner diameter of 2.18 mm and an outer diameter of 3.18 mm was used.

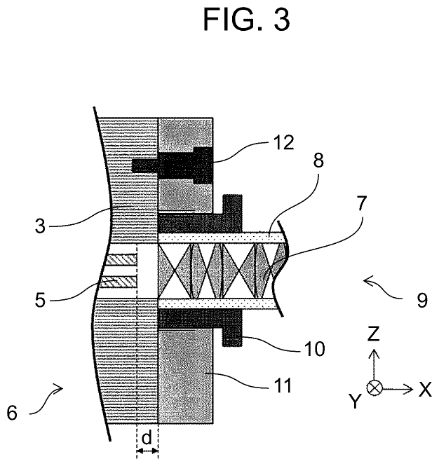

FIG. 3 is an enlarged sectional view illustrating a flowing state of a fluid at a connection place between liquid-contact component 6 and static mixer unit 9 in Example 1.

Static mixer unit 9 includes fluid mixture structure 7 and third tubular body 8 inserted into fluid mixture structure 7. Fluid mixture structure 7 is fixed in third tubular body 8 in which a tip of fluid mixture structure 7 aligns with a tip of third tubular body 8.

To connect liquid-contact component 6 to static mixer unit 9, static mixer connector 11 made of SUS316 was prepared by being processed to have inner diameter conforming to the screw standard of ¼-28UNF. Static mixer connector 11 was connected to liquid-contact component 6 by fastening an end surface of first tubular body 3 with screw 12, the end surface being not connected to second tubular body 5.

Fluid mixer 1 was prepared by connecting static mixer unit 9 to a part of static mixer connector 11, the part conforming to the screw standard of ¼-28UNF, and assembling static mixer unit 9 with fitting 10 in contact with the end surface of first tubular body 3. Assembling in this manner acquired gap length “d” of 2.18 mm that was a distance by which second tubular body 5 and fluid structure 7 were physically separated from each other.

### <Method for Manufacturing Lithium Aluminum Fluoride Fine Particles>

Aqueous solution A and mixed solution B were prepared. Aqueous solution A was acquired by dissolving ammonium fluoride in pure water to have a concentration of 750 mM. Mixed solution B was acquired by dissolving and mixing lithium nitrate and aluminum nitrate in pure water. Mixed solution B contained the lithium nitrate at a concentration of 375 mM and the aluminum nitrate at a concentration of 125 mM. Aqueous solution A was fed to a first pipe at a flow rate of 10 mL/min using a plunger pump (UI-22) manufactured by FLOM Corporation.

Mixed solution B was fed to a second pipe at a flow rate of 10 mL/min using the plunger pump (UI-22) manufactured by FLOM Corporation. When solution A and mixed solution B were mixed in fluid mixer 1, a crystallization reaction proceeded to manufacture an aqueous solution containing lithium aluminum fluoride fine particles. The manufacturing was performed for one hour, and a PFA tube having an inner diameter of 2.18 mm, an outer diameter of 3.18 mm, and a length of 2 m was connected downstream of static mixer unit 9 to collect the manufactured aqueous solution containing lithium aluminum fluoride fine particles. To manufacture lithium aluminum fluoride fine particles having crystal structure with high quality, fluid mixer 1 performed the manufacturing while being immersed in a warm bath at 60° C.

### <Method for Evaluating Deposit Prevention and Removal Effect on Channel and Mixing Performance of Fluid Mixer 1>

To evaluate deposit prevention and removal effect on a channel of fluid mixer 1, a sensor section of a pressure sensor unit (FC-PSU-1000) manufactured by DFC Co., Ltd. was connected to a pipe for transporting the second fluid, and a pressure profile inside the pipe for transporting the second fluid was measured. For determination of adhesion prevention and removal effect of a product on the channel of fluid mixer 1, when a maximum pressure increase value from the start of synthesis was 0.2 MPa or more, the adhesion prevention and removal effect of a product was determined to be low. When the maximum pressure increase value was 0.1 MPa or more and less than 0.2 MPa, the adhesion prevention and removal effect of a product on the channel was determined to be effective, and when the maximum pressure increase value was less than 0.1 MPa, the adhesion prevention and removal effect of a product on the channel was determined to be more effective.

To evaluate the mixing performance of fluid mixer 1, particle sizes of the manufactured lithium aluminum fluoride fine particles were measured using a particle size measurement system (ELSZ-2000) manufactured by Otsuka Electronics Co., Ltd. The particle sizes increase under low mixing performance in reaction of lithium aluminum fluoride fine particles in the synthesis. Thus, when the particle sizes had an average of larger than 1 μm, the mixing performance was determined to be low, and when the particle sizes had an average of smaller than 1 μm, the mixing performance was determined to be high.

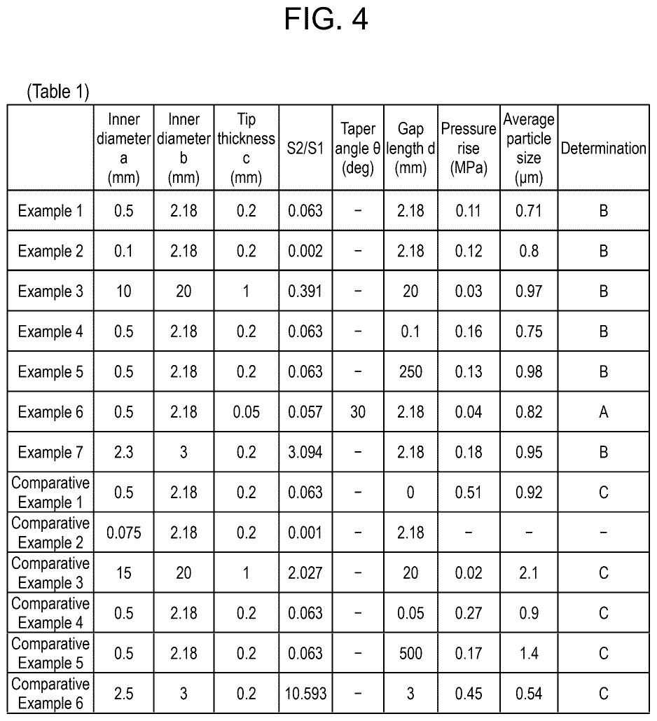

FIG. 4 is Table 1 showing measurement results. Fluid mixer 1 determined to be low in adhesion prevention and removal effect of a product on the channel or to be low in mixing performance was evaluated as “C”. Fluid mixer 1 determined to be effective in adhesion prevention and removal effect of a product on the channel and to be high in mixing performance was evaluated as “B”. Fluid mixer 1 determined to be more effective in adhesion prevention and removal effect of a product on the channel and to be high in mixing performance was evaluated as “A”.

The results in Table 1 reveal that fluid mixer 1 according to Example 1 had adhesion prevention and removal effect of a product on the channel and had high mixing performance as long as second tubular body 5 and fluid mixture structure 7 were not in physical contact with each other.

### Comparative Example 1

Second tubular body 5 was prepared causing the tip of second tubular body 5 to be in contact with fluid mixture structure 7. Specifically, lithium aluminum fluoride fine particles were manufactured, and mixing performance, and adhesion prevention and removal effect of a product on the channel, during the manufacturing were evaluated as in Example 1 except that gap length “d” was changed to 0. Measurement results at this time are shown in Table 1.

The results in Table 1 reveal that fluid mixer 1 had no adhesion prevention and removal effect of a product on the channel when second tubular body 5 and fluid mixture structure 7 were in physical contact with each other.

Comparison between Example 1 and Comparative Example 1 reveals that fluid mixer 1 according to Example 1 was able to have the adhesion prevention and removal effect of a product on the channel while having the mixing performance due to a structure in which second tubular body 5 and fluid mixture structure 7 were not in physical contact with each other.

### Example 2

Mixing performance, and adhesion prevention and removal effect of a product on the channel of fluid mixer 1 including second tubular body 5 with inner diameter “a” of 0.1 mm were investigated. Specifically, lithium aluminum fluoride fine particles were manufactured, and the mixing performance and deposit adhesion prevention effect on the channel during the manufacturing were evaluated as in Example 1 except that fluid mixer 1 was prepared causing second tubular body 5 to have inner diameter “a” of 0.1 mm. Measurement results at this time are shown in Table 1.

The results in Table 1 reveal that when second tubular body 5 had inner diameter “a” of 0.1 mm, fluid mixer 1 had not only the adhesion prevention and removal effect of a product on the channel, but also high mixing performance.

### Example 3

Mixing performance, and adhesion prevention and removal effect of a product on the channel of fluid mixer 1 including second tubular body 5 with inner diameter “a” of 10 mm were investigated. Specifically, lithium aluminum fluoride fine particles were manufactured, and the mixing performance and deposit adhesion prevention effect on the channel during the manufacturing were evaluated as in Example 1 except that fluid mixer 1 was prepared causing second tubular body 5 to have inner diameter “a” of 10 mm, first tubular body 3 to have inner diameter “b” of 20 mm, and second tubular body 5 to have a tip with thickness “c” of 1. Measurement results at this time are shown in Table 1.

The results in Table 1 reveal that when second tubular body 5 had inner diameter “a” of 10 mm, fluid mixer 1 had not only the adhesion prevention and removal effect of a product on the channel, but also high mixing performance.

### Comparative Example 2

Mixing performance, and adhesion prevention and removal effect of a product on the channel of fluid mixer 1 including second tubular body 5 with inner diameter “a” of 0.075 mm were investigated. Specifically, lithium aluminum fluoride fine particles were manufactured, and the mixing performance, and the adhesion prevention and removal effect of a product on the channel, during the manufacturing were evaluated as in Example 1 except that fluid mixer 1 was prepared causing second tubular body 5 to have inner diameter “a” of 0.075 mm. Unfortunately, processing of second tubular body 5 and assembly of fluid mixer 1 were very difficult, so that second tubular body 5 was distorted in structure to fail to transport the second fluid to second tubular body 5. Thus, lithium aluminum fluoride fine particles failed to be manufactured. For this reason, measurement results at this time are shown as “-” in Table 1.

The results in Table 1 reveal that fluid mixer 1 did not function as an application for mixing a plurality of fluids when second tubular body 5 had inner diameter “a” of 0.075 mm.

### Comparative Example 3

Mixing performance, and adhesion prevention and removal effect of a product on the channel of fluid mixer 1 including second tubular body 5 with inner diameter “a” of 15 mm were investigated. Specifically, lithium aluminum fluoride fine particles were manufactured, and the mixing performance, and the adhesion prevention and removal effect of a product on the channel, during the manufacturing were evaluated as in Example 1 except that fluid mixer 1 was prepared causing second tubular body 5 to have inner diameter “a” of 15 mm, first tubular body 3 to have inner diameter “b” of 20 mm, and second tubular body 5 to have a tip with thickness “c” of 1 mm. Measurement results at this time are shown in Table 1.

The results in Table 1 reveal that when second tubular body 5 had inner diameter “a” of 15 mm, the adhesion prevention and removal effect of a product on the channel were effective, but the mixing performance was low.

Comparison between Examples 2 and 3, and Comparative Examples 2 and 3 reveals that when second tubular body 5 had inner diameter “a” from 0.1 mm to 10 mm inclusive, fluid mixer 1 had not only the adhesion prevention and removal effect of a product on the channel, but also high mixing performance.

### Example 4

Mixing performance, and adhesion prevention and removal effect of a product on the channel of fluid mixer 1 in which a relational expression between gap length “d” and inner diameter “a” was “d=0.2a” were investigated. Specifically, lithium aluminum fluoride fine particles were manufactured, and the mixing performance, and the adhesion prevention and removal effect of a product on the channel, during the manufacturing were evaluated as in Example 1 except that second tubular body 5 was prepared having gap length “d” of 0.1 mm. Measurement results at this time are shown in Table 1.

The results in Table 1 reveal that when the relational expression between gap length “d” and inner diameter “a” was “d=0.2a”, fluid mixer 1 had not only the adhesion prevention and removal effect of a product on the channel, but also high mixing performance.

### Example 5

Mixing performance, and adhesion prevention and removal effect of a product on the channel of fluid mixer 1 in which a relational expression between gap length “d” and inner diameter “a” was “d=500a” were investigated. Specifically, lithium aluminum fluoride fine particles were manufactured, and the mixing performance, and the adhesion prevention and removal effect of a product on the channel, during the manufacturing were evaluated as in Example 1 except that second tubular body 5 was prepared having gap length “d” of 250 mm. Measurement results at this time are shown in Table 1.

The results in Table 1 reveal that when the relational expression between gap length “d” and inner diameter “a” was “d=500a”, fluid mixer 1 had not only the adhesion prevention and removal effect of a product on the channel, but also high mixing performance.

### Comparative Example 4

Mixing performance, and adhesion prevention and removal effect of a product on the channel of fluid mixer 1 in which a relational expression between gap length “d” and inner diameter “a” was “d=0.1a” were investigated. Specifically, lithium aluminum fluoride fine particles were manufactured, and the mixing performance, and the adhesion prevention and removal effect of a product on the channel, during the manufacturing were evaluated as in Example 1 except that second tubular body 5 was prepared having gap length “d” of 0.05 mm. Measurement results at this time are shown in Table 1.

The results in Table 1 reveal that when the relational expression between gap length “d” and inner diameter “a” was “d=0.1a”, fluid mixer 1 had low adhesion prevention and removal effect of a product on the channel.

### Comparative Example 5

Mixing performance, and adhesion prevention and removal effect of a product on the channel of fluid mixer 1 in which a relational expression between gap length “d” and inner diameter “a” was “d=1000a” were investigated. Specifically, lithium aluminum fluoride fine particles were manufactured, and the mixing performance, and the adhesion prevention and removal effect of a product on the channel, during the manufacturing were evaluated as in Example 1 except that fluid mixer 1 was prepared having gap length “d” of 500 mm. Measurement results at this time are shown in Table 1.

The results in Table 1 reveal that when the relational expression between gap length “d” and inner diameter “a” was “d=1000a”, fluid mixer 1 had low mixing performance.

Comparison between Examples 4 and 5, and Comparative Examples 4 and 5 reveals that when a relational expression between gap length “d” and inner diameter “a” satisfies Expression (1) below,

$$2 a \leq d \leq 500 a , \qquad ( 1 )$$

fluid mixer 1 has adhesion prevention and removal effect of a product on the channel, and high mixing performance.

### Example 6

Mixing performance, and adhesion prevention and removal effect of a product on the channel of fluid mixer 1 including second tubular body 5 with a tip in a tapered shape were investigated. Specifically, lithium aluminum fluoride fine particles were manufactured, and the mixing performance, and the adhesion prevention and removal effect of a product on the channel, during the manufacturing were evaluated as in Example 1 except that fluid mixer 1 was prepared with the tip of second tubular body 5, the tip being processed to have taper angle θ of 30°. Measurement results at this time are shown in Table 1.

The results in Table 1 reveal that when the tip of second tubular body 5 had a tapered shape, fluid mixer 1 had not only excellent adhesion prevention and removal effect of a product on the channel, but also high mixing performance.

Comparison between Example 1 with Example 6 reveals that when the tip of second tubular body 5 had a tapered shape, fluid mixer 1 had more excellent adhesion prevention and removal effect of a product on the channel.

### Example 7

Mixing performance and adhesion prevention effect on the channel of fluid mixer 1 having S2/S1 of 3.094 were investigated. Specifically, lithium aluminum fluoride fine particles were manufactured, and the mixing performance, and the adhesion prevention and removal effect of a product on the channel, during the manufacturing were evaluated as in Example 1 except that fluid mixer 1 was prepared causing second tubular body 5 to have inner diameter “a” of 2.3 mm and first tubular body 3 to have inner diameter “b” of 3 mm. Measurement results at this time are shown in Table 1.

The results in Table 1 reveal that fluid mixer 1 having S2/S1 of 3.094 had not only the adhesion prevention and removal effect of a product on the channel, but also high mixing performance.

### Comparative Example 6

Mixing performance, and adhesion prevention and removal effect of a product on the channel of fluid mixer 1 having S2/S1 of 10.593 were investigated. Specifically, lithium aluminum fluoride fine particles were manufactured, and the mixing performance, and the adhesion prevention and removal effect of a product on the channel, during the manufacturing were evaluated as in Example 1 except that fluid mixer 1 was prepared causing second tubular body 5 to have inner diameter “a” of 2.5 mm and first tubular body 3 to have inner diameter “b” of 3 mm. Measurement results at this time are shown in Table 1.

The results in Table 1 reveal that fluid mixer 1 having S2/S1 of 10.593 had low adhesion prevention and removal effect of a product on the channel.

Comparison between Example 7 and Comparative Example 6 reveals that when S2/S1 was 3.094 or more, fluid mixer 1 had not only the adhesion prevention and removal effect of a product on the channel, but also high mixing performance.

### INDUSTRIAL APPLICABILITY

A fluid mixer according to an aspect of the present disclosure has deposit prevention effect on a channel while having mixing performance that enables rapid mixing. Thus, this fluid mixer can also be applied to a mixer for synthesizing fine particles, polymers, and proteins in a channel, and a mixer for recycling a raw material in which an element dissolved in a solvent is precipitated and collected as a solid content.

### REFERENCE MARKS IN THE DRAWINGS

1 fluid mixer
2 first pipe connector
3 first tubular body
4 second pipe connector
5 second tubular body
6 liquid-contact component
7 fluid mixture structure
8 third tubular body
9 static mixer unit
10 fitting
11 static mixer connector
12 screw
13 cavity
14 end surface
15 cavity
16 inner surface

1. A fluid mixer comprising:
a liquid-contact component including
a first tubular body and
a second tubular body disposed to form a double tube in a portion inside the first tubular body, the liquid-contact component allowing a first fluid to flow between an inner wall of the first tubular body and an outer wall of the second tubular body, and allowing a second fluid to flow inside the second tubular body; and
a static mixer unit fluidly connected to the liquid-contact component, the static mixer unit including a fluid mixture structure that promotes mixing of the first fluid and the second fluid,
wherein the second tubular body includes a tip, and a gap is provided between the tip and the fluid mixture structure.

2. The fluid mixer according to claim 1, wherein the second tubular body has an inner diameter “a” from 0.1 mm to 10 mm inclusive.

3. The fluid mixer according to claim 1, wherein
the second tubular body is physically separated from the fluid mixture structure by a gap length “d”, and
the gap length “d” satisfies Expression (1) below:
0.2a≤d≤500a (1).

4. The fluid mixer according to claim 1, wherein the tip of the second tubular body has a tapered shape.

5. The fluid mixer according to claim 1, wherein
the fluid mixer has a sectional area S2 and an area S1 that satisfy Expression (2) below,
S2/S1≤3.09 (2 ),
where the sectional area S2 is a sectional area of an inner peripheral part of the second tubular body in an end surface of the tip of the second tubular body, and
the area S1 is an area obtained by subtracting a sectional area of an outer peripheral part of the second tubular body from a sectional area of an inner peripheral part of the first tubular body.
